(19) United States
(12) Patent Application Publication
(10) Pub. No.: US 2013/0064109 A1
(43) Pub. Date: Mar. 14, 2013

(54) Analyzing Internet Traffic by Extrapolating Socio-Demographic Information from a Panel

(71) Applicants: Jacques Combet, Levallois-Perret (FR); Gerard Hermet, Paris (FR)

(72) Inventors: Jacques Combet, Levallois-Perret (FR); Gerard Hermet, Paris (FR)

(21) Appl. No.: 13/230,616

(22) Filed: Sep. 12, 2011

(51) Int. Cl. H04W 24/00

(52) U.S. Cl. 370/252

(57) ABSTRACT

A network intelligence solution (NIS) is arranged to tap a stream of IP (Internet Protocol) packets traversing a node in a network that supports a mobile communications service between mobile equipment employed by subscribers in a universe of subscribers to the service and one or more remote servers such as web servers. The NIS performs deep packet inspection to measure Internet usage by the universe of subscribers as well as usage by a subscriber panel that is a representative subset of the universe. A unique network identifier is generated, for example using the MSISDN (Mobile Subscriber Integrated Services Digital Network Number) associated with each subscriber which is anonymized, to enable socio-demographic information collected from the subscriber panel to be correlated to the panel's Internet usage. The correlations can then be extrapolated to make generalizations about socio-demographics of the larger subscriber universe.

### CROSS-REFERENCE TO RELATED APPLICATIONS

This application is related to U.S. Patent Applications respectively entitled “System and Method for Automated Classification of Web Pages and Domains”, “System and Method for Relating Internet Usage with Mobile Equipment”, and “A Method for Segmenting Users of Mobile Internet” each being filed concurrently herewith and owned by the assignee of the present invention, and the disclosure of which is incorporated by reference herein in its entirety.

### BACKGROUND

Communication networks provide services and features to users that are increasingly important and relied upon to meet the demand for connectivity to the world at large. Communication networks, whether voice or data, are designed in view of a multitude of variables that must be carefully weighed and balanced in order to provide reliable and cost effective offerings that are often essential to maintain customer satisfaction. Accordingly, being able to analyze network activities and manage information gained from the accurate measurement of network traffic characteristics is generally important to ensure successful network operations.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A network intelligence solution (NIS) is arranged to tap a stream of IP (Internet Protocol) packets traversing a node in a network that supports a mobile communications service between mobile equipment employed by subscribers in a universe of subscribers to the service and one or more remote servers such as web servers. The NIS performs deep packet inspection to measure Internet usage by the universe of subscribers as well as usage by a subscriber panel that is a representative subset of the universe. A unique network identifier is generated, for example using the MSISDN (Mobile Subscriber Integrated Services Digital Network Number) associated with each subscriber which is anonymized, to enable socio-demographic information collected from the subscriber panel to be correlated to the panel's Internet usage. The correlations can then be extrapolated to make generalizations about socio-demographics of the larger subscriber universe.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative mobile communications network environment that facilitates access to resources by users of mobile equipment and with which the present system and method may be implemented;

FIG. 2 shows an illustrative web browsing session which utilizes a request-response communication protocol;

FIG. 3 shows an illustrative NIS that may be located in a mobile communications network or node thereof and which processes information from traffic flowing in the network to measure Internet usage;

FIG. 4 shows an illustrative deep packet inspection machine that may be utilized to perform measurements of Internet usage;

FIG. 5 shows a panel formed as a subset of a universe of subscribers to a mobile communications network service and the collection of socio-demographic information therefrom;

FIG. 6 shows an illustrative taxonomy of criteria for the socio-demographic information that is collected from each member of the subscriber panel;

FIG. 7 shows the measurement of Internet usage of subscribers in the panel having known socio-demographics and of subscribers in the larger universe having unknown socio-demographics;

FIG. 8 shows use of an illustrative correlation engine for performing analyses of data including socio-demographic information and Internet usage measurements that are collected from the panel;

FIG. 9 shows how correlations made between Internet usage and socio-demographic criteria from the subscriber panel may be extrapolated to the larger subscriber universe; and

FIG. 10 is a flowchart of an illustrative method for analyzing Internet traffic by extrapolating socio-demographic information from a subscriber panel.

Like reference numerals indicate like elements in the drawings. Unless otherwise indicated, elements are not drawn to scale.

### DETAILED DESCRIPTION

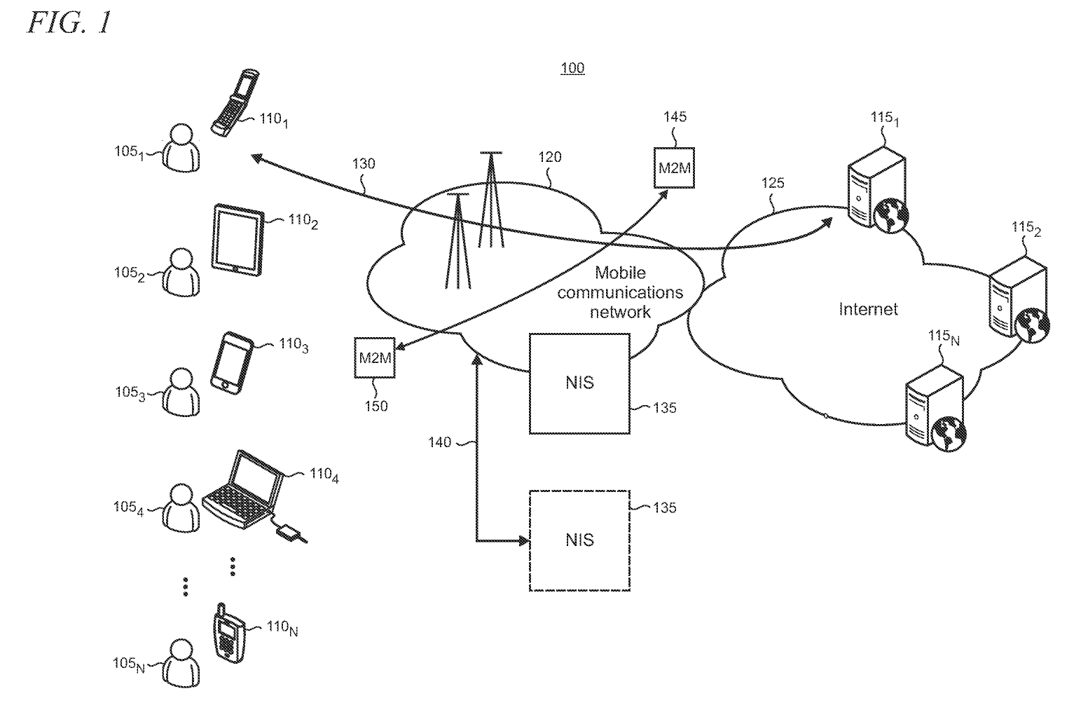

FIG. 1 shows an illustrative mobile communications network environment 100 that facilitates access to resources by users 105_{1, 2 . . . N} of mobile equipment 110_{1, 2 . . . N} and with which the present arrangement for analyzing Internet traffic may be implemented. In this example, the resources are web-based resources that are provided from various web servers 115_{1, 2 . . . N}. Access is implemented, in this illustrative example, via a mobile communications network 120 that is operatively connected to the web servers 115 via the Internet 125. It is emphasized that the present system and method are not necessarily limited in applicability to mobile communications network implementations and that other network types that facilitate access to the World Wide Web including local area and wide area networks, PSTNs (Public Switched Telephone Networks), and the like that may incorporate both wired and wireless infrastructure may be utilized in some implementations. In this illustrative example, the mobile communications network 120 may be arranged using one of a variety of alternative networking standards such as GPRS (General Packet Radio Service), UMTS (Universal Mobile Telecommunications System), GSM/EDGE (Global System for Mobile Communications/Enhanced Data rates for GSM Evolution), CDMA (Code Division Multiple Access), CDMA2000, or other 2.5G, 3G, 3G+, or 4G (2.5^{th} generation, 3^{rd} generation, 3^{rd} generation plus, and 4^{th} generation, respectively) wireless standards, and the like.

The mobile equipment 110 may include any of a variety of conventional electronic devices or information appliances that are typically portable and battery-operated and which may facilitate communications using voice and data. For example, the mobile equipment 110 can include mobile phones (e.g., non-smart phones having a minimum of 2.5G capability), e-mail appliances, smart phones, PDAs (personal digital assistants), ultra-mobile PCs (personal computers), tablet devices, tablet PCs, handheld game devices, digital media players, digital cameras including still and video cameras, GPS (global positioning system) navigation devices, pagers, electronic devices that are tethered or otherwise coupled to a network access device (e.g., wireless data card, dongle, modem, or other device having similar functionality to provide wireless Internet access to the electronic device), or devices which combine one or more of the features of such devices. Typically, the mobile equipment 110 will include various capabilities such as the provisioning of a user interface that enables a user 105 to access the Internet 125 and browse and selectively interact with web pages that are served by the Web servers 115, as representatively indicated by reference numeral 130.

The network environment 100 may also support communications among machine-to-machine (M2M) equipment and facilitate the utilization of various M2M applications. In this case, various instances of peer M2M equipment (representatively indicated by reference numerals 145 and 150) or other infrastructure supporting one or more M2M applications will send and receive traffic over the mobile communications network 120 and/or the Internet 125. In addition to accessing traffic on the mobile communications network 120 in order to relate Internet usage and socio-demographic information, the present arrangement may also be adapted to access M2M traffic traversing the mobile communications network. Accordingly, while the methodology that follows is applicable to an illustrative example in which Internet usage of mobile equipment users is measured, those skilled in the art will appreciate that a similar methodology may be used when M2M equipment is utilized.

A NIS 135 is also provided in the environment 100 and operatively coupled to the mobile communications network 120, or to a network node thereof (not shown) in order to access traffic that flows through the network or node. In alternative implementations, the NIS 135 can be remotely located from the mobile communications network 120 and be operatively coupled to the network, or network node, using a communications link 140 over which a remote access protocol is implemented. In some instances of remote operation, a buffer (not shown) may be disposed in the mobile communications network 120 for locally buffering data that is accessed from the remotely located NIS.

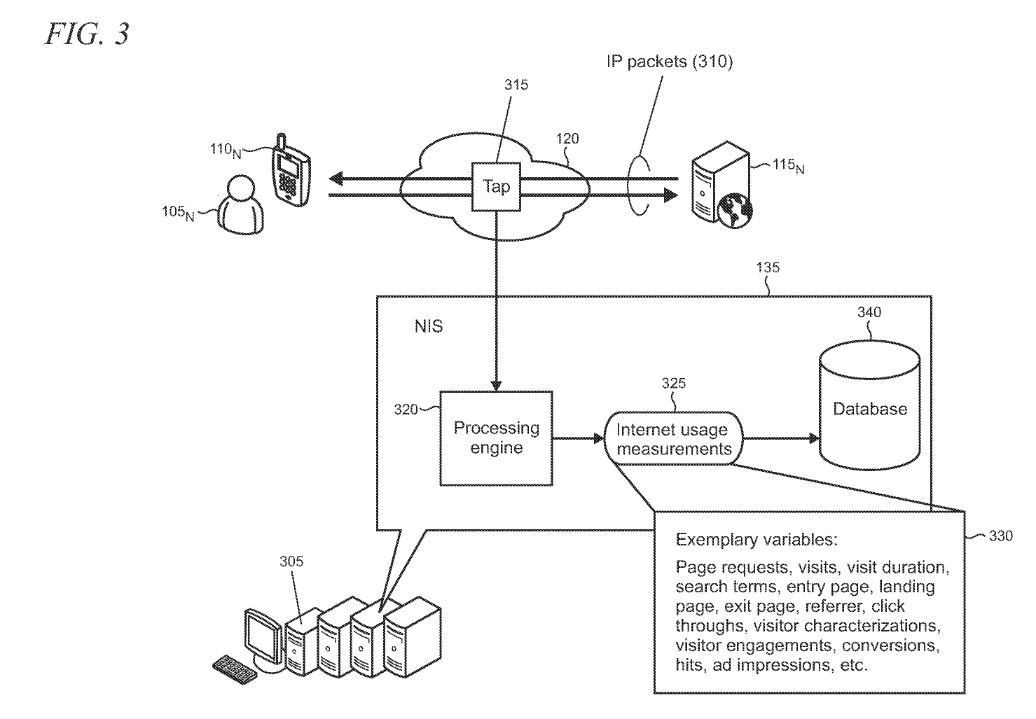

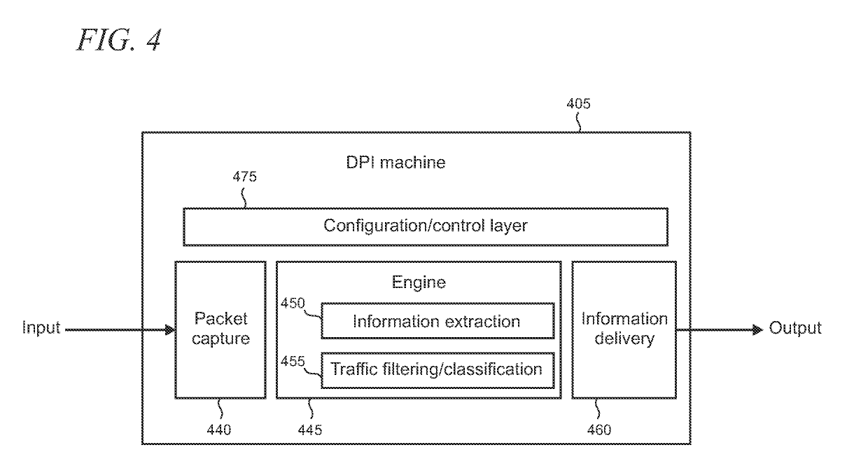

It is noted that performing network traffic analysis from a network-centric viewpoint can be particularly advantageous in many scenarios. For example, attempting to collect information at the mobile equipment 110 can be problematic because such devices are often configured to utilize thin client applications and typically feature streamlined capabilities such as reduced processing power, memory, and storage compared to other devices that are commonly used for web browsing such as PCs. In addition, collecting data at the network advantageously enables data to be aggregated across a number of instances of mobile equipment 110, and further reduces intrusiveness and the potential for violation of personal privacy that could result from the installation of monitoring software at the client. The NIS 135 is described in more detail in the text accompanying FIGS. 3 and 4 below.

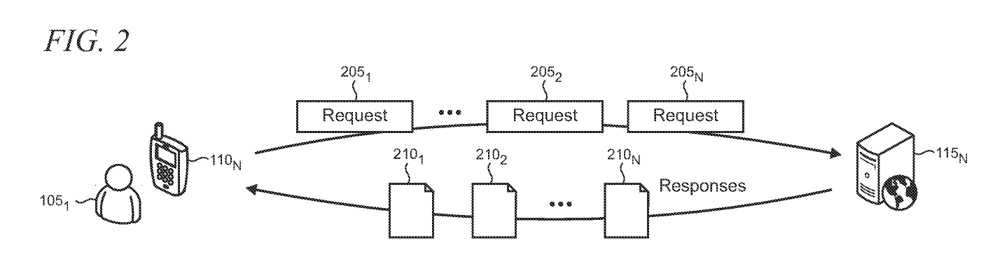

FIG. 2 shows an illustrative web browsing session which utilizes a protocol such as HTTP (HyperText Transfer Protocol) or SIP (Session Initiation Protocol). In this particular illustrative example, the web browsing session utilizes HTTP which is commonly referred to as a request-response protocol that is typically utilized to transfer Web files. Each transfer consists of file requests 205_{1, 2 . . . N} for pages or objects from a browser application executing on the mobile equipment 110 to a server 115 and corresponding responses 210_{1, 2 . . . N} from the server. Thus, at a high level, the user 105 interacts with a browser to request, for example, a URL (Uniform Resource Locator) to identify a site of interest, then the browser requests the page from the server 115. When receiving the page, the browser parses it to find all of the component objects such as images, sounds, scripts, etc., and then makes requests to download these objects from the server 115.

FIG. 3 shows details of the NIS 135 which is arranged, in this illustrative example, to collect and analyze network traffic through the mobile communications network 120 in order to make measurements of Internet usage by the users 105 of the mobile equipment 110. The NIS 135 is typically configured as one or more software applications or code sets that are operative on a computing platform such as a server 305 or distributed computing system. In alternative implementations, the NIS 135 can be arranged using hardware and/or firmware, or various combinations of hardware, firmware, or software as may be needed to meet the requirements of a particular usage scenario. As shown, network traffic typically in the form of IP packets 310 flowing through the mobile communications network 120, or a node of the network, is captured via a tap 315. A processing engine 320 takes the captured IP packets to make measurements of Internet usage 325 which can be typically written to one or more databases (representatively indicated by reference numeral 340) in common implementations.

As shown in FIG. 3, exemplary variables 330 that may be measured include page requests, visits, visit duration, search terms, entry page, landing page, exit page, referrer, click throughs, visitor characterizations, visitor engagements, conversions, hits, ad impressions, and the like. It is emphasized that the exemplary variables shown in FIG. 3 are intended to be illustrative and that the number and particular variables that are utilized in any given application can differ from what is shown as required by the needs of a given application.

As shown in FIG. 4, the NIS 135 can be implemented, at least in part, using a deep packet inspection (DPI) machine 405. DPI machines are known and commercially available examples include the ixMachine produced by Qosmos SA. The IP packets 310 (FIG. 3) are collected in a packet capture component 440 of the DPI machine 405. An engine 445 takes the captured IP packets to extract various types of information, as indicated by reference numeral 450, and filter and/or classify the traffic, as indicated by reference numeral 455. An information delivery component 460 of the DPI machine 405 then outputs the data generated by the DPI engine 445. Software code may execute in a configuration and control layer 475 in the DPI machine 405 to control the DPI engine output and information delivery 460. In some implementations of the DPI machine 405, an API (application programming interface) (not shown in FIG. 4) can be specifically exposed to enable certain control of the DPI machine responsively to remote calls to the interface.

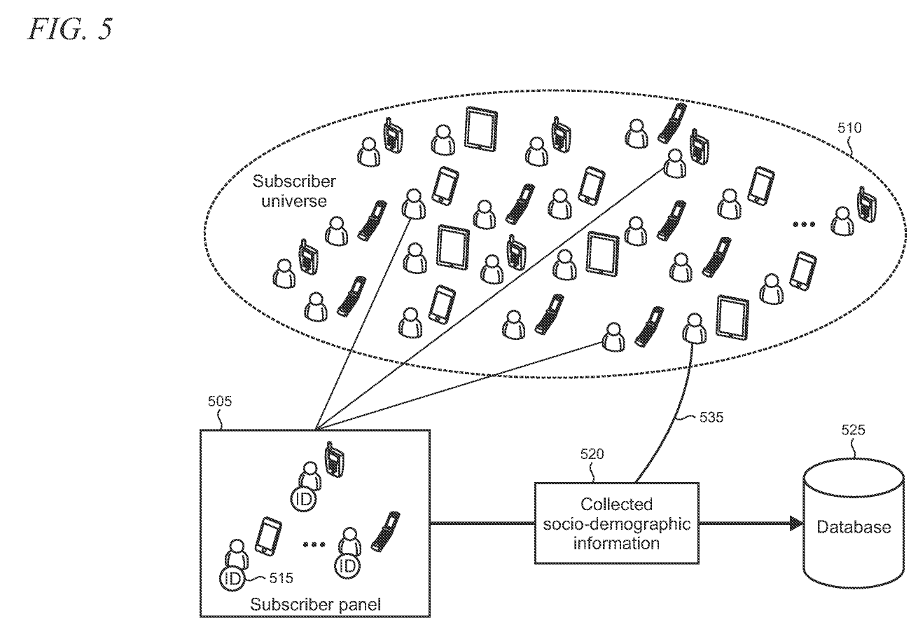

FIG. 5 shows a panel 505 formed as a subset of a universe of subscribers 510 to one or more services that may be supported by the mobile communications network 120 shown in FIG. 1 and described in the accompanying text. The subscriber universe 510 can typically include an arbitrary portion or substantially all of the subscribers to the mobile communications services. Alternatively, the subscriber universe may be defined as a specific portion or segment of service subscribers. For example, a particular addressable market may constitute the subscriber universe in some applications in which the addressable market is segmented or characterized (e.g., by geographic region, time of network access, subscription type, roaming users vs. non-roaming users, etc.).

The subscriber panel 505 is typically arranged to be representative of the subscriber universe 510 in a statistically valid sense. Being a sample of a larger population, the panel 505 will generally be populated by using a sampling plan that enables panel members to be scientifically chosen so that each subscriber in the universe will have a measurable chance of selection, i.e., a known probability of selection. In this way, the data gained from analysis of the subscriber panel's Internet usage and socio-demographics can be reliably extrapolated to the larger subscriber universe with known levels of certainty and/or precision. In other words, standard errors and confidence intervals may be constructed using probability sampling. Accordingly, in many typical applications of the present arrangement, the panel 505 can be a probability-based panel sample that is representative of the subscriber universe 510. In some applications, the panel sample is not an equal probability sample as intentional over-sampling of certain subgroups having particular socio-demographic criteria may be performed to enhance reliability or to reduce panel implementation costs. For example, various weighting schemes can be applied when oversampling, or post-stratification adjustments may be utilized, to reduce bias due to non-sampling error.

Non-probability sampling techniques, where the selection of members of the panel is not entirely random, may be utilized in alternative embodiments in which probability sampling is impractical or cost prohibitive. For example, various subgroups or demographic profiles may be selected according to fixed quotas (i.e., quota sampling) or panel members may be selected that are considered to be the most representative of the subscriber universe (i.e., judgment sampling). An opt-in or other form of self-selecting subscriber panel may also be used with satisfactory results in some cases, although such panels can be expected to exhibit some bias and thus not be completely representative of the subscriber universe which typically leads to greater non-sampling error. Non-probability samples can be generally limited in their ability to be extrapolated to the larger population without introducing a larger margin of error as would be obtained when using probability sampling.

As shown in FIG. 5, each member of the subscriber panel 505 can be uniquely identified by some form of identifier (ID), as representatively indicated by reference numeral 515, so that socio-demographic information 520 can be collected from the panel and mapped to specific members. That is, utilization of the ID 515 enables Internet usage by a given panel member to be related to the socio-demographic information of that panel member. The ID may be generated using the MSISDN, for example, in those applications where the mobile communications network 120 (FIG. 1) is compliant with GSM or UMTS. The MSISDN may be anonymized on the fly and transformed into a unique hexadecimal key (and a similar ID-generating methodology can also be used for socio-demographic data when collected from the larger subscriber universe 510 using pre-existing mobile operator databases, as described below). Typically, utilization of the ID 515 may be effectuated in a manner that enables the mapping while still allowing personally identifying information to be anonymized. The collected socio-demographic information 520 will typically be written to a database 525.

In addition to collecting socio-demographic information from the subscriber panel, or as an alternative to such collection in some cases, socio-demographic information may be collected from subscribers in the universe 510 who are not panel members. This collection from the subscriber universe is representatively indicated by reference numeral 535 in FIG. 5. Various collection methodologies may be utilized including, for example, accessing existing databases of customer information (not shown in FIG. 5) that are owned and/or maintained by the mobile network operator, or accessing information from third party sources (not shown). The existing databases may include, for example, those associated with mobile operator billing systems and customer relationship management (CRM) systems. Typically, access to and use of customer data in the databases is compliant with terms of use to which the subscribers agree and various anonymization techniques are utilized to preserve customer privacy, as described in more detail below. Accordingly, while the description below refers to socio-demographic information that is collected from the subscriber panel, it should be understood that such collection can also be applicable to data from existing databases and sources depending on the requirements of a particular application.

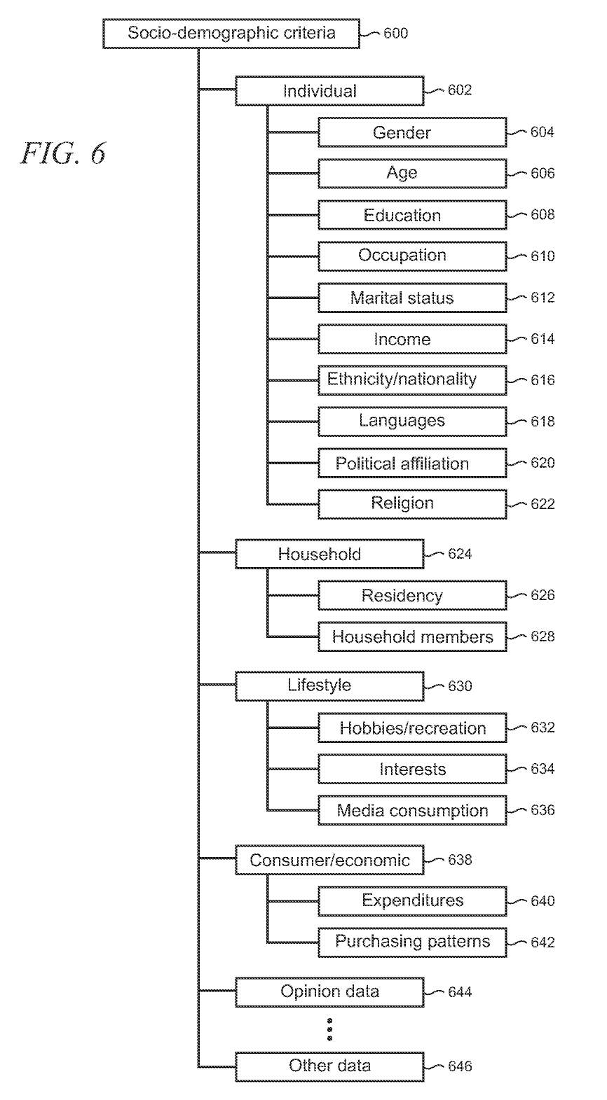

FIG. 6 shows an illustrative taxonomy 600 of criteria (i.e., variables) for the socio-demographic information that is collected from each member of the subscriber panel 505 (FIG. 5). Various direct and indirect data collection methodologies may be utilized such as questionnaires, personal interviews, and the like. It is emphasized that the categories and criteria shown in FIG. 6 and described below are intended to be illustrative and that other categories and criteria, in various combinations or sub-combinations, may be utilized to meet the needs of a particular application of the present arrangement. Not all of the criteria in the illustrative taxonomy 600 need to be utilized in every application.

As shown, the taxonomy 600 includes individual socio-demographic criteria 602, which can comprise, for example, criteria pertaining to gender 604, age 606, education 608, occupation 610, marital status 612, income 614, ethnicity or nationality 616, languages 618, political affiliation 620, and religion 622. Household socio-demographic criteria 624 can comprise, for example, criteria pertaining to residency 626 (e.g., location/region, size of city/town, length of time in residence, owner/renter, transportation methods, etc.) and household members 628 (e.g., children and extended family and ages/gender thereof, pets, etc.). Lifestyle socio-demographic criteria 630 can comprise, for example, hobbies/recreation 632, interests 634, and media consumption 636 (e.g., print, television, radio, computer-usage, etc.) of the subscribers. Consumer and economic socio-demographic criteria 638 can comprise, for example, expenditures 640 (e.g., household budget, expense categories, etc.) and purchasing patterns 642 (e.g., buying habits, planned purchases, etc.). The socio-demographic criteria 600 can also comprise opinion data 644 (e.g., data about beliefs/opinions held by the subscribers regarding various topics/subjects) or other data 646.

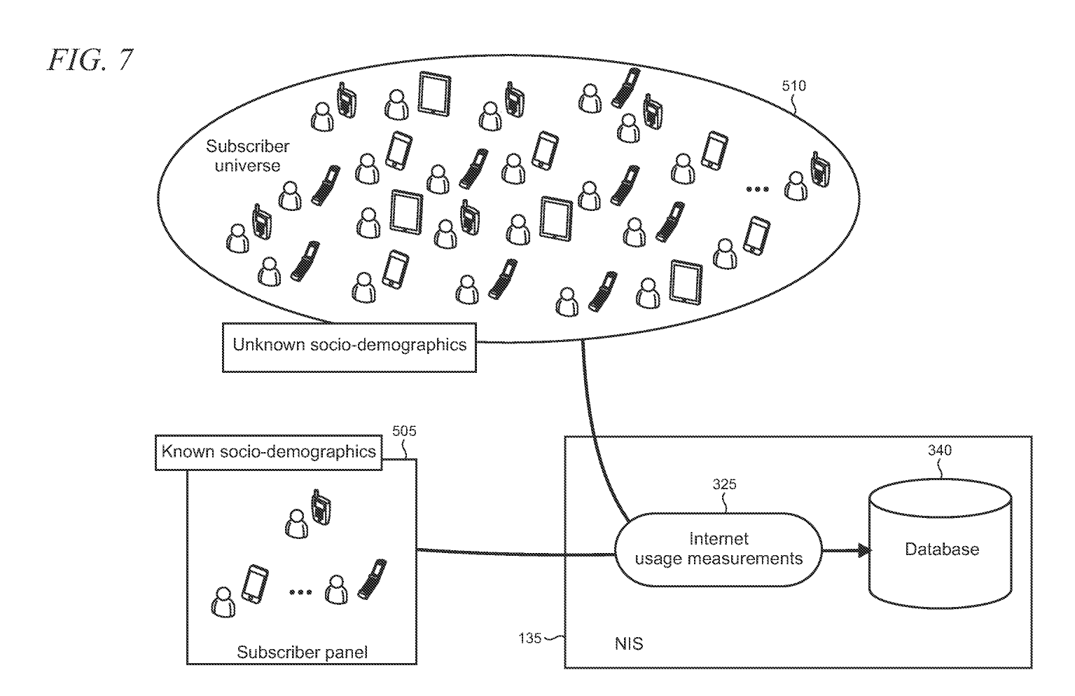

As shown in FIG. 7, the NIS 135 is utilized to measure Internet usage of both subscribers in the panel 505 for which socio-demographics are known, as well for subscribers in the larger universe 510 for which socio-demographics are unknown. As noted above, since each of the members of the panel is identified by a unique ID, specific Internet usage may be mapped to specific panel members so that analyses can be performed to identify relationships between socio-demographic criteria and Internet usage measurements.

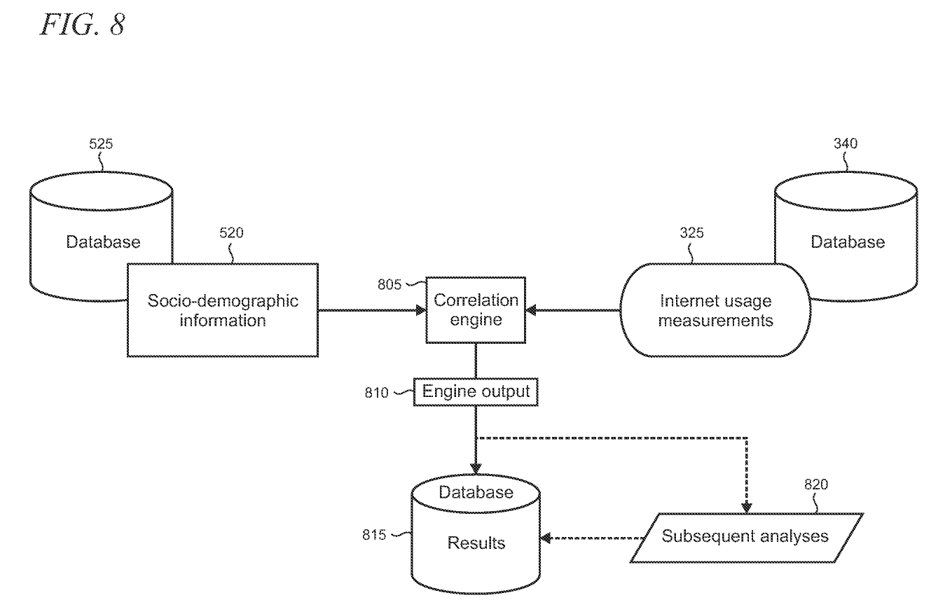

FIG. 8 shows use of an illustrative correlation engine 805 for performing such analyses of data including socio-demographic information 520 and Internet usage measurements 325 that are collected from the panel. In this example, the correlation engine 805 is utilized so that one or more criteria included in the socio-demographic information 520 can be correlated to one or more variables included in the Internet usage measurements 325 of subscriber panel members. For example, analysis of the data may indicate the strength of correlation between highest education level achieved (i.e., a socio-demographic criteria) and the amount of video content consumed (i.e., an Internet usage metric). It is emphasized that the preceding example is merely illustrative and that a wide variety of different analyses, associations, or correlations may be performed on the collected socio-demographic information and Internet usage measurements as may be needed to meet the requirements of a particular application.

The correlation engine 805 may be implemented in the NIS 135 (FIG. 1) using functionality provided by the DPI machine 405 (FIG. 4) or as standalone functionality in some instances. The output 810 from the correlation engine 805 may be written to a results database 815 or transmitted to a remote destination in some cases. Alternatively, subsequent analyses may be performed, as indicated by reference numeral 820.

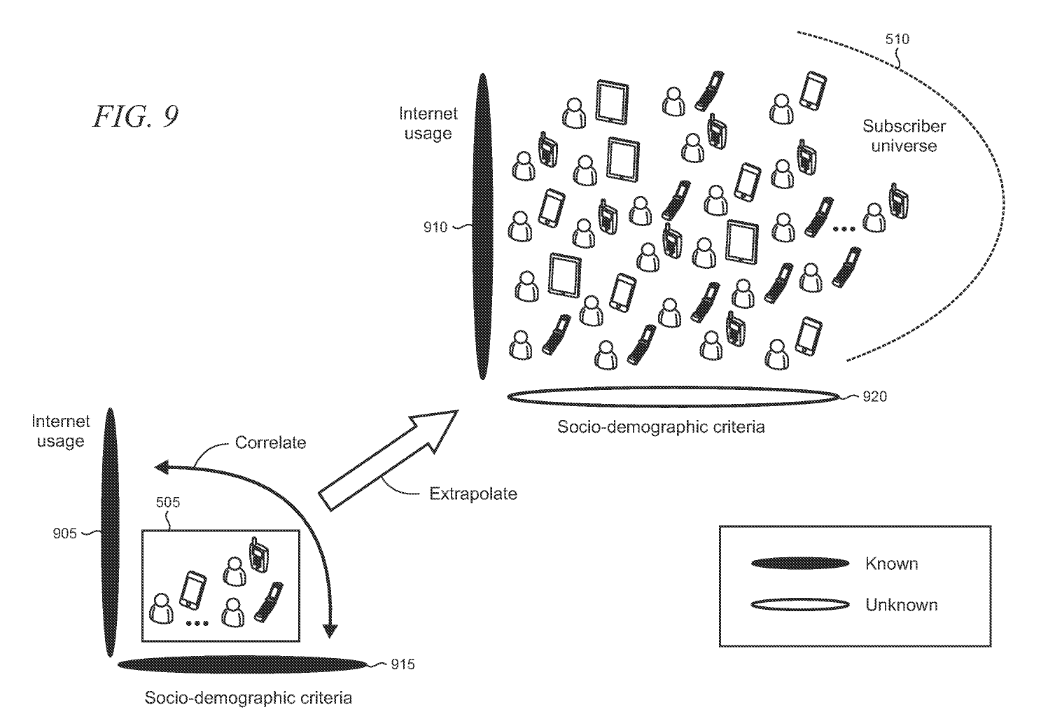

FIG. 9 shows how correlations made between Internet usage and socio-demographic criteria from the subscriber panel 505 may be extrapolated to the larger subscriber universe 510. More specifically, Internet usage is known for both the subscriber panel 505 and the subscriber universe 510 (as respectively indicated by reference numerals 905 and 910). And as the Internet usage of the panel 505 may be correlated to the known socio-demographic criteria 915, inferences may be made regarding the unknown socio-demographic criteria 920 of the subscriber universe 510. For example, if analysis of the subscriber panel 505 shows a strong correlation between one or more socio-demographic criteria and visits to a particular website, then the measured visits to that site from members of the larger subscriber universe can suggest that such members possess the one or more socio-demographic criteria within some significance level or margin of error.

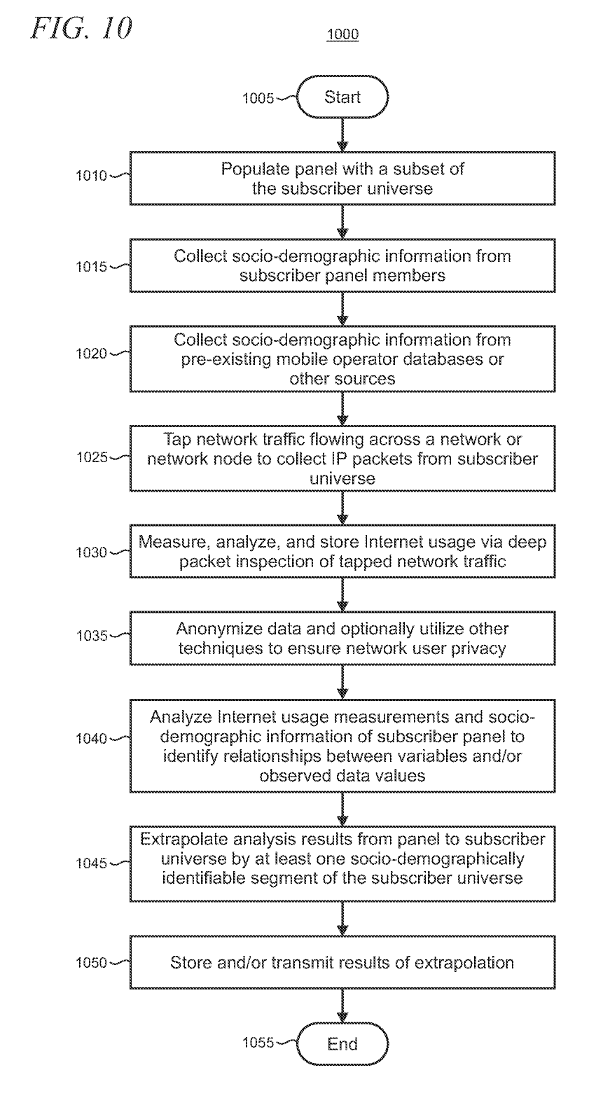

FIG. 10 shows a flowchart of an illustrative method 1000 for analyzing Internet traffic by extrapolating socio-demographic information from the subscriber panel 505 (FIG. 5). The method begins at block 1005. At block 1010, the subscriber panel 505 is populated using a subset of the subscriber universe 510. In typical applications, the subscriber panel is selected using a probability sampling methodology with appropriate randomization techniques and controls. Socio-demographic information is collected from the members of the subscriber panel at block 1015. Exemplary socio-demographic criteria are shown in FIG. 6 and described in the accompanying text. Socio-demographic information may be collected from pre-existing mobile operator databases (e.g., billing, CRM) or other sources at block 1020.

At block 1025, traffic flowing across a network or network node is tapped to collect IP packets. At block 1030, Internet usage is measured, analyzed, and stored for all of the subscribers (i.e., both panel members and members of the subscriber universe) typically using deep packet inspection where exemplary metrics for the measurement and analysis are shown in FIG. 3 by reference numeral 330. At block 1035, data utilized by the NIS 135 (FIGS. 1, 3, and 7), or portions thereof can be anonymized to remove identifying information from the data, for example, to ensure that privacy of the network access device users is maintained. It is emphasized that while the method step in block 1035 is shown as occurring after block 1030, the anonymization described here may generally be included as part of the step shown in block 1030 or alternatively applied to the captured data at any point in the method 1000. Other techniques may also be optionally utilized in some implementations of model-based information management to further enhance privacy including, for example, providing notification to the users 105 that certain anonymized data may be collected and utilized to enhance network performance or improve the variety of features and services that may be offered to users in the future, and providing an opportunity to opt out (or opt in) to participation in the collection.

End-user privacy may be preserved by irreversibly anonymizing all Personally Identifiable Information (PII) present in the extracted data. This anonymization takes into account both direct and indirect exposure of user privacy by applying a multitude of methods. Direct PII refers to names, numbers, and addresses that could as such identify an individual end-user, while indirect PII refers to the use of rare devices, applications, or content that could potentially identify an individual end-user.

Confidentiality of communications is fully respected and maintained in the present arrangement, as no private communications content is collected. More specifically, the majority of data is extracted from packet headers, and data from packet payloads is extracted only on specific cases where part of the payload in question is known to be public content, such as in the case of traffic sent in known format by known advertising servers. The data is collected by default on a census basis, but mechanisms for filtering in the data of opt-in end-users and filtering out the data of opt-out users are also supported.

At block 1040, the Internet usage measurements and socio-demographic information pertaining to the subscriber panel 505 may be analyzed to identify relationships between variables or observed data from the respective measurements and information. Such analyses may include statistical analyses such as correlation and association.

At block 1045, the results of the analyses performed in block 1040 may then be extrapolated from the panel 505 to the larger subscriber universe 510 as a whole across at least one socio-demographically identifiable segment of the subscriber universe. That is, inferences as to the socio-demographics of the subscriber universe 510 can be made to some acceptable significance level or margin of error based on the correlations between the Internet usage and socio-demographic information pertaining to the subscriber panel 505.

The results of the extrapolation may be stored or transmitted to remote locations at block 1050. The method ends at block 1055.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for analyzing Internet traffic, the method comprising the steps of:
tapping a stream of IP packets comprising traffic traversing a mobile communications network between mobile equipment employed by a universe of subscribers of a service operating on the network and one or more remote Internet servers;
measuring Internet usage of the universe of subscribers by inspecting the IP packet stream;
collecting socio-demographic information from a panel of subscribers, the panel being selected from a subset of the universe;
relating the collected socio-demographic information to measurements of Internet usage of the panel of subscribers; and
extrapolating results from the relating step to the universe of subscribers.

2. The method of claim 1 in which the inspecting comprises performing deep packet inspection.

3. The method of claim 1 in which the relating comprises statistical analysis selected from at least one of correlation or association.

4. The method of claim 1 in which the socio-demographic information comprises at least one of individual criteria, household criteria, lifestyle criteria, consumer criteria, or opinion criteria.

5. The method of claim 1 in which the subscriber panel is selected using a probability sampling methodology.

6. The method of claim 1 in which the extrapolating is performed to make generalizations about unknown socio-demographics of the subscriber population.

7. The method of claim 1 in which the tapped stream of IP packets is subjected to anonymization to maintain privacy of the universe of subscribers.

8. The method of claim 1 further including a step of transmitting results of the extrapolating step.

9. A method for implementing a network intelligence solution having access to a stream of IP packets that traverse a node in a network that supports a mobile communications service, the IP packets being streamed between multiple instances of mobile equipment employed by respective subscribers in a universe of subscribers to the service and web servers on the Internet, the method comprising the steps of:
receiving a unique ID for identifying each member of a subscriber panel, the subscriber panel being a representative subset of the subscriber universe;
collecting socio-demographic information from the subscriber panel;
storing the collected socio-demographic information according to the unique ID of each member of the subscriber panel;
measuring Internet usage by the universe of subscribers, including the subscriber panel, during web-browsing sessions performed over the network in which Internet usage by the subscriber panel is stored by unique ID; and
extrapolating Internet usage by the subscriber panel to make inferences about socio-demographics of the subscriber universe.

10. The method of claim 9 including a further step of configuring the network intelligence solution with a deep packet inspection machine that measures the Internet usage by performing deep packet inspection of the stream of IP packets.

11. The method of claim 9 in which the Internet usage is measured using one or more of page requests, visits, visit duration, search terms, entry page, landing page, exit page, referrer, click throughs, visitor characterizations, visitor engagements, conversions, hits, or ad impressions.

12. The method of claim 9 in which the mobile equipment comprises one of mobile phone, e-mail appliance, smart phone, non-smart phone, M2M equipment, PDA, PC, ultra-mobile PC, tablet device, tablet PC, handheld game device, digital media player, digital camera, GPS navigation device, pager, wireless data card, wireless dongle, wireless modem, or device which combines one or more features thereof.

13. The method of claim 9 in which the extrapolation is performed across at least one socio-demographically identifiable segment of the subscriber universe.

14. The method of claim 9 in which the collecting is performed using one of questionnaire or interview.

15. A computer-implemented method analyzing Internet traffic, the method comprising the steps of:
recruiting a panel of subscribers that is a representative subset of a universe of subscribers to a service operating on a mobile communications network;
collecting from each member of the subscriber panel i) socio-demographic information and ii) a unique network ID;
monitoring Internet usage over the mobile communications network by the universe of subscribers;
writing the monitored Internet usage to a database;
identifying from the database Internet usage of the subscriber panel using the unique network IDs of each member of the subscriber panel;
correlating Internet usage by the subscriber panel to the collected socio-demographic information; and
extrapolating the correlated Internet usage by at least one socio-demographically identifiable segment of the subscriber universe.

16. The computer-implemented method of claim 15 in which the collecting is performed during web-browsing sessions.

17. The computer-implemented method of claim 15 in which the collecting is performed by tapping IP traffic traversing a node of the mobile communications network.

18. The computer-implemented method of claim 15 in which the at least one socio-demographically identifiable segment of the subscriber universe is at least a portion of an addressable market.

19. The computer-implemented method of claim 15 in which the unique network ID is generated by anonymizing an MSISDN.

20. The computer-implemented method of claim 19 including a further step of anonymizing the MSISDN on the fly.
